(19) United States
(12) Patent Application Publication
(10) Pub. No.: US 2017/0351796 A1
(43) Pub. Date: Dec. 7, 2017

(54) METHOD FOR IMPROVING THE RUNTIME PERFORMANCE OF MULTI-CLOCK DESIGNS ON FPGA AND EMULATION SYSTEMS

(71) Applicant: Prateek Sikka, New Delhi (IN)

(72) Inventor: Prateek Sikka, New Delhi (IN)

(21) Appl. No.: 15/414,077

(22) Filed: Jan. 24, 2017

(30) Foreign Application Priority Data
Jun. 6, 2016 (IN) 201611019463

(51) Int. Cl. G06F 17/50

(52) U.S. Cl. CPC G06F 17/5031; G06F 17/5054; G06F 17/5027; G06F 17/505

(57) ABSTRACT

The present invention provides a method to improve the run time of a SoC design on FPGA and emulation system. A design with multiple clocks is divided or split into multiple smaller designs and is then coupled by synchronizer circuit. The method is particularly more effective in a design where the ratio of highest to lowest clock frequency is high or where clock frequencies are not in even ratios.

### FIELD OF INVENTION

The present invention relates to a method for performing testing and verification of a design in FPGA or Emulation systems and improving their runtime performance.

### PRIOR ART AND PROBLEM TO BE SOLVED

The IC design complexity is increasing and therefore the time required to verify each design is also increasing. A design has multiple functional blocks, which may range from few hundred to millions of gates and hence may require simulation time between a few hours to a few days, depending on the complexity.

Typically, emulation systems and FPGAs are used to speed up the verification time of the target system design. For complex designs, FPGAs or Emulation engines are faster than simulation tools by orders of magnitude.

The software tool chain analyses and synthesizes the HDL design in the form of gates. The emulation database is used to emulate a design and verify its functionality at a much faster pace than the conventional PC based simulators. The hardware emulation engines may have different architectures. Typically, they may be FPGA, LUT or high performance CPU array based structures.

As the time to market is shrinking, the need for hardware and software development for SOC projects and the role of emulation and hardware prototyping is growing rapidly in the design flow. Simulation of close to real chip scenarios and timely fixing of design bugs in the design cycle is further driving the need for availability of emulation hardware/ FPGA platform at very early stage in the VLSI design cycle. However, these acceleration hardware resources are expensive and it is important to make efficient use of these.

Further, due to increase in the complexity of designs, designing of compilers to handle such designs is also getting tough. Designs having complex clock trees and frequency plans are one such example.

Also, as the designs grow larger in size, the complexity of placement and routing is increasing, thus causing the critical paths to grow longer and hence maximum compile frequency (F-max as reported by synthesis tools) is reduced.

Therefore, for complex designs with multiple clocks and unevenly distributed clock frequencies, we typically end up with a low synthesis frequency.

The prior-arts are described below that are directed towards improving the run time of a Design in FPGA. U.S. Pat. No. 6,760,277 defines an arrangement for generating multiple clocks in field programmable gate arrays (FPGAs) of a network test system. The invention is a test system for a design of a network device under test and includes an oscillator configured for generating a first clock signal for a first clock domain, and FPGAs. Each FPGA is configured for performing device operations according to the first clock domain and transferring data to another device at a network data rate based on a second clock domain. Each FPGA includes clock conversion logic configured for generating a second clock signal for the second clock domain, based on the first clock signal. Hence, the generation of the second clock signal within each FPGA ensures that timing accuracy is maintained, enabling communication between FPGAs at high-speed data rates based on the second clock domain. However, such an arrangement does not work if the design under test has multiple input clocks or if the subsystems or parts of the design are working at different frequencies (specially, if they are not even multiples of each other).

Also, U.S. Pat. No. 7,973,565 discloses resonant clock and interconnect architecture for digital devices with multiple clock networks. It proposes a clock and data distribution network that distributes clock and data signals without buffers, thus achieving very low jitter, skew, loose timing requirements, and energy consumption. Such network uses resonant drivers and is generally applicable to architectures for programmable logic devices (PLDs) such as field programmable gate arrays (FPGAs), as well as other semiconductor devices with multiple clock networks operating at various clock frequencies.

Some of these devices are high-performance and have low-power clocking requirements such as microprocessors, applications specific integrated circuits (ARCO, and Systems-on-a-Chip (SOCs). Again, the above invention helps in ensuring better and balanced clock distribution but does not address the cases where the clock frequencies are different.

Therefore, there is a need for a solution to overcome the aforesaid difficulties. The present invention provides a method to improve the emulation performance of a design on FPGA or Emulator i.e. time taken to run a verification test on a design.

### SUMMARY OF THE INVENTION

The primary object of the present invention is to provide a method to improve the run time performance of a design with multiple and different frequency clocks.

Another object of the present invention is to provide a method to improve the synthesis frequency for complex designs by breaking-up a design having multiple clocks into multiple smaller designs and couple them through synchronizers.

The present invention is particularly more effective where the ratio of fastest clock of the design to the slowest clock is very high or where the clock frequencies are not even multiples of each other.

Other objects and advantages of the present invention will become apparent from the following description taken in connection with the accompanying drawings, wherein, by way of illustration and example, the aspects of the present invention are disclosed.

### BRIEF DESCRIPTION OF THE DRAWINGS

The present invention will be better understood after reading the following detailed description of the presently preferred aspects thereof with reference to the appended drawings, in which:

FIG. 1 illustrates the flow chart delineating the method of working of present invention;

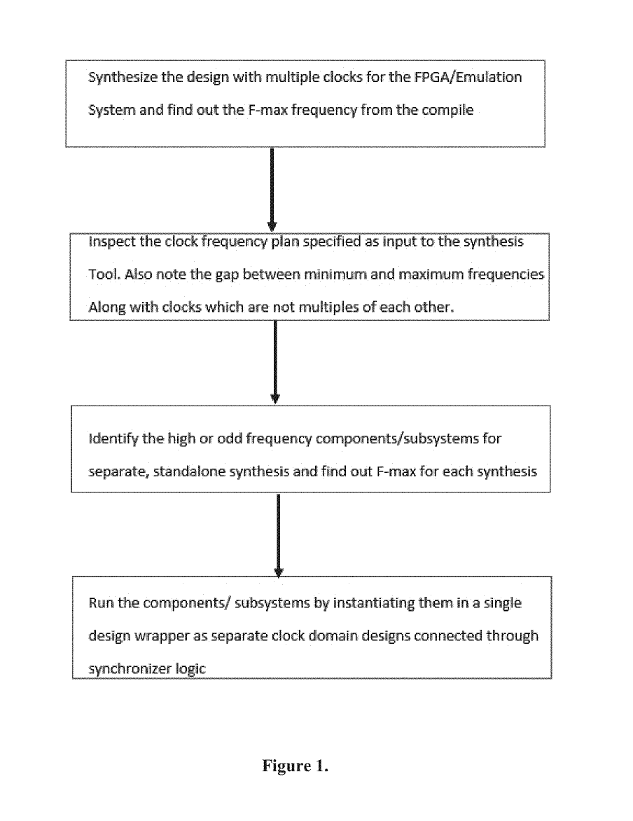

FIG. 2 illustrates the block diagram of original design (single domain); and

FIG. 3 illustrates the block diagram of modified design (multi-domain).

### DETAILED DESCRIPTION OF THE INVENTION

The following description describes various features and functions of the disclosed method with reference to the accompanying figures. In the figures, similar symbols identify similar components, unless context dictates otherwise. The illustrative aspects described herein are not meant to be limiting. It may be readily understood that certain aspects of the disclosed method can be arranged and combined in a wide variety of different configurations, all of which are contemplated herein.

The mapping of a design on hardware prototype has many advantages such as reduced verification time of the design and achieving design maturity at a very early stage of VLSI design flow.

When a design with complex clock trees is synthesized onto an FPGA hardware using a compiler tool chain, complex timing paths are created and hence it gets difficult for the compiler to perform an efficient placement and routing and obtain a high F-max. In general, we observe that higher the design complexity, the lower is the F-max. Also, higher the F-max, the better is the runtime performance for the design.

Therefore, a strong methodology is required to improve the synthesis frequency for complex clock tree designs. This reduces time to market and also helps in better utilization of emulation resources by enabling more runs in the finite amount of time.

The main aspect of the present invention is a method that ensures better compilation frequency and hence a better run time speed. The method is applicable for a specific class of system designs. In the method, SoC design on FPGA/Emulation tool is synthesized and compile/ synthesis frequency (F-max) is obtained. The clock frequency plan of a design is inspected to determine the ratio of maximum frequency to minimum frequency or the clock frequencies that are not even multiples of each other. The sub-systems for separate standalone synthesis are identified and the F-max is obtained for individual sub-systems. All the sub-systems are then run together in a single design wrapper as separate clock domain designs, connected through synchronizers.

In the present invention, a design with multiple clocks is divided into multiple smaller designs and is then coupled by synchronizer circuitry. The method is particularly more effective in a design where the ratio of highest to lowest clock frequency is high or the clock frequencies that are not even multiples of each other. In any FPGA or emulation compiler toolchain, all the design clocks are derived from the fastest clock with the help of dividers.

For example, a design has 3 clocks say 100 MHz, 50 MHz and 10 MHz Assuming that after placement and routing, F-max is 2 kHz, so the design clocks are running at 2 kHz, 1 kHz and 200 Hz respectively (in the same ratios as specified design clocks) in the real world.

Now, if the design runs for 200 cycles of the slowest clock, the entire test case takes 1 second to complete on the emulation platform (1/200 s *200). If we run 10 MHz clock at 2 kHz instead of 200 Hz, then the same design runs for 0.1s (1/2000*200), achieving a 10× speedup in the overall run time.

The present method treats the subsystems/blocks of the designs running at different frequencies as separate small independent designs and connect them using a wrapper through synchronizer circuits, thereby achieving better runtime frequency for the overall design. The method is particularly helpful when there is large difference between the fastest clock and slowest clock or where clock frequencies are not in even ratios. e.g. , if a design has, four clock frequencies: 1 MHz, 1 MHz, 1 MHz and 1600 MHz, using the present method, we could achieve a maximum of 1600× over the conventional runtime for the same design.

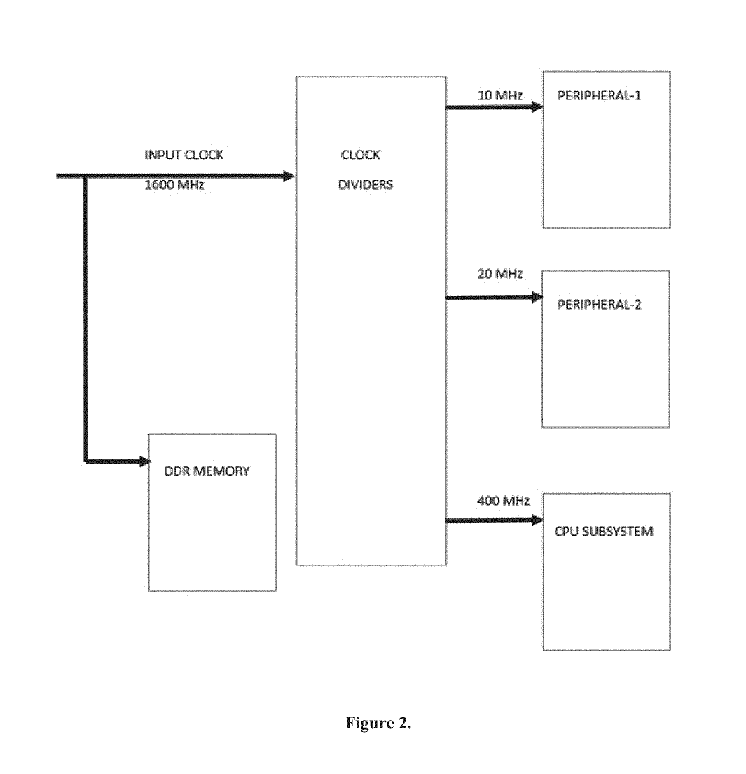

Taking another example, as shown in FIG. 2, a design is synthesized in conventional manner, where F-max is 2 kHz. Therefore,
1600 MHz clock runs at 2 kHz (2000 Hz)
400 MHz clock runs at 0.5 kHz (500 Hz)
10 MHz clock runs at 12.5 Hz
It is seen that the slowest clock of 10 MHz actually runs at 12.5 Hz.

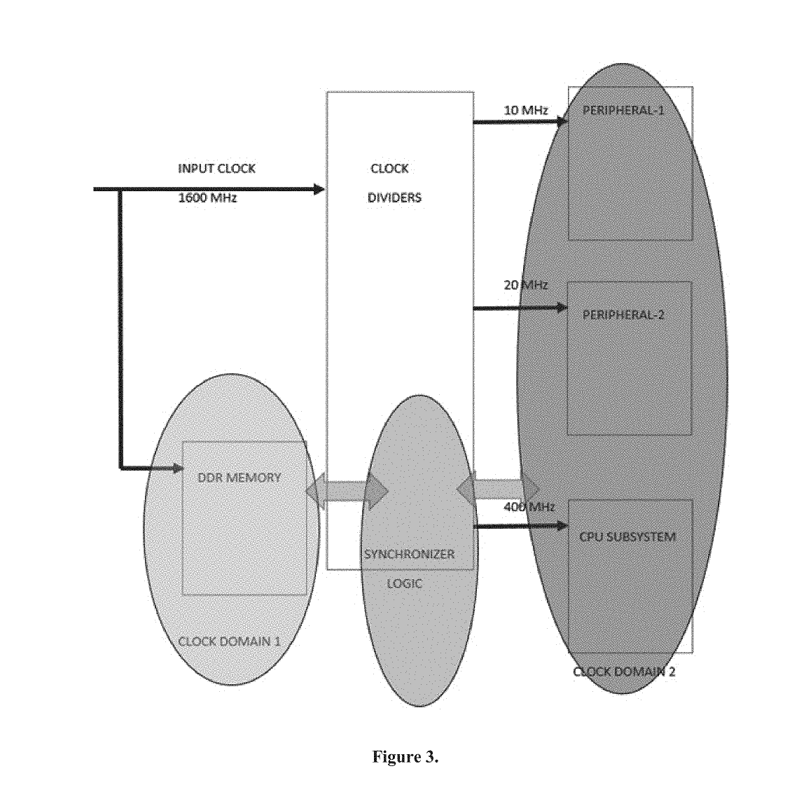

However, for the same maximum frequency if the design is partitioned depending on its clock, to work as a different design altogether, the implementation changes as follows (FIG. 3):
1600 MHz clock runs at 2 kHz (Design1)
400 MHz clock runs at 2 kHz (Design 2)
10 MHz clock runs at 50 Hz (Design 2)
Therefore, a 4-× emulation performance is achieved using the method of the present invention.

In another example, if a design has three clock frequencies: 100 MHz, 50 MHz and 101 MHz therefore, using the present method, we could achieve a better emulation performance for the same design by dividing the design as follows:
100 MHz clock-Design 1
50 MHz clock-Design 1
101 MHz clock-Design 2

The method is easily scalable for any number of clocks that the Design Under Test (DUT) has. The method is easily scalable and the concept can be extended to 2.3.4 . . . N different clock domains.

The method can be used for any kind of FPGA or emulation platform and the compile speed (F-max) and run time speed is better optimized for a multi-clock design running on it.

The method works for multiple frequency designs as well as FPGA boards of all capacities and characteristics. It does not cause any functionality change and can be used in any verification environment. This method is useful where partitioning of design into multiple smaller designs is possible.

Since the run time of a test is reduced, the present method helps in reducing the regression time and hence verification time, which in turn helps to reduce time to market for electronic VLSI designs. Further, the reduced run time helps in optimal usage of emulator up time and thus operation cost is also reduced indirectly.

The method is scalable for any number of clocks provided there is a definite ratio between the clocks. The number of different designs to be placed in single compile can be easily calculated by analyzing the clock ratios in the original design.

While the present invention has been described with reference to one or more preferred aspects, which aspects have been set forth in considerable detail for the purposes of making a complete disclosure of the invention, such aspects are merely exemplary and are not intended to be limiting or represent an exhaustive enumeration of all aspects of the invention. The scope of the invention, therefore, shall be defined solely by the following claims. Further, it will be apparent to those of skill in the art that numerous changes may be made in such details without departing from the spirit and the principles of the invention.

I CLAIM:

1. A method for improving the compile time synthesis frequency of a design on FPGA or emulation system, wherein the method comprising:
synthesizing SoC design on FPGA or Emulation system and obtaining compile or synthesis frequency (F-max);
inspecting clock frequency of the design to determine the difference between the clock frequencies and their relative ratios;
identifying and separating the high frequency or odd frequency sub-systems for stand-alone synthesis; and
running the sub-systems together as separate clock domain designs and connecting them through synchronizer circuits.

2. The method as claimed in claim 1, wherein the difference between the ratio of the maximum clock frequency and minimum clock frequency of the sub-system is high or the clock frequencies are not even multiples of each other.

3. The method as claimed in claim 1, wherein the different slower design clocks are derived from the fastest clock of the design by means of divider circuitry.
